(19) United States
(12) Patent Application Publication
(10) Pub. No.: US 2009/0036808 A1
(43) Pub. Date: Feb. 5, 2009

(54) APPARATUS FOR HEAD ACUPRESSURE USING AIR PRESSURE

(76) Inventor: Yong-Ho Ki, Gyeonggi-do (KR)

Correspondence Address: LEXYOUME IP GROUP, LLC, 5180 PARKSTONE DRIVE, SUITE 175, CHANTILLY, VA, 20151, US

(21) Appl. No.: 12/096,642

(22) PCT Filed: Dec. 21, 2006
(86) PCT No.: PCT/KR2006/005634

§ 371 Date: Jun. 9, 2008

(30) Foreign Application Priority Data
Dec. 22, 2005 (KR) 20-2005-0036077

(51) Int. Cl. A61H 7/00

(52) U.S. Cl. 601/134

(57) ABSTRACT

The present invention relates to a plurality of pneumatic cylinders each having an acupressure probe is radially mounted in a predetermined space portion defined between an inner shell and an outer shell made of an extruded foam synthetic resin material, and an pneumatic pressure generator serving to actuate the pneumatic cylinders is mounted separately from the helmet, so that its whole weight is light, no noise or vibration occurs, and it is very simple to use and carry.

### TECHNICAL FIELD

The present invention relates to a pneumatic scalp acupressure apparatus, and more particularly, to such a pneumatic scalp acupressure apparatus, in which a plurality of pneumatic cylinders each having an acupressure probe is radially mounted in a pre-determined space portion defined between an inner shell and an outer shell made of an extruded foam synthetic resin material, and an pneumatic pressure generator serving to actuate the pneumatic cylinders is mounted separately from the helmet, so that its whole weight is light, no noise or vibration occurs, and it is very simple to use and carry.

### BACKGROUND ART

Conventionally, there have been disclosed scalp acupressure apparatuses of various types for patients who require a scalp acupressure massage such as patients suffering from alopecia or chronic headache. For example, Korean Patent Laid-Open Publication No. 2000-31855 (laid-opened on Jun. 5, 2000) discloses a scalp acupressure massage machine in which hydraulic syringes of several hundreds are radially mounted inside a helmet, and each hydraulic syringe has a tip installed at a lower distal end thereof so as to allow the tip to apply acupressure to a user's scalp. However, the acupressure massage machine disclosed in the foregoing Korean patent document does never suggest the detailed drawings or description on how the hydraulic syringes operate structurally, especially how a hydraulic tube for supplying hydraulic pressure to each hydraulic syringe is mounted inside the helmet. Accordingly, it will not be considered that those skilled in the art easily manufacture the scalp acupressure massage machine which can operate actually based on technical contents disclosed in the above Korean document.

Although the scalp acupressure massage machine is manufactured based on the structure taught in the Korean Patent Laid-Open Publication No. 2000-31855, it still entails a problem in that the weight and volume of the helmet is heavy and large as being configured of a hydraulic type. Such a hydraulic scalp acupressure apparatus encounters a critical shortcoming that since its weight and volume is heavy and large, it is not suitable for a user who wears it for receiving a scalp acupressure massage for a long time.

Such conventional scalp acupressure apparatuses have a disadvantage in that it is inconvenient to use since their weight and size is heavy and large. Also, some apparatuses often cause a serious problem in that a noise or vibration generated during their operation is directly transferred to a user's head, or an electromagnetic wave detrimental to the human body is emitted to thereby threaten the health of the user.

### DISCLOSURE OF INVENTION

### Technical Problem

Accordingly, the present invention has been made in an effort to address and solve the above-mentioned problems occurring in the prior art, it is an object of the present invention to provide a pneumatic scalp acupressure apparatus, in which a plurality of pneumatic cylinders each having an acupressure probe is radially mounted in a pre-determined space portion formed between an inner shell and an outer shell made of a foamed synthetic resin material which is lightweight and excellent in strength, so that its whole weight is light, no noise or vibration occurs, and it is very simple to use and carry.

### Technical Solution

To accomplish the above object, according to the present invention, there is provided a pneumatic scalp acupressure apparatus comprising: a helmet including an inner shell and an outer shell which are formed in a hemispherical shape and made of a foamed synthetic resin material, and a space portion defined between the inner shell and the outer shell; a plurality of pneumatic cylinder units mounted radially in the space portion of the helmet, each pneumatic cylinder unit including an acupressure probe mounted at a lower end thereof to pass through the inner shell of the helmet; a pneumatic pressure generator for generating air pressure to supply the generated air pressure to the inside of each of the pneumatic cylinder units, the pneumatic pressure generator including an air pump and an air valve interconnected to the plurality of pneumatic cylinder units through a pneumatic tube, and a control unit for controlling the operation of the air pump and the air valve.

In the present invention, each of the pneumatic cylinder units includes a cylindrical cylinder having a ventilation tube formed at an upper portion thereof, a pressure plate mounted inside the cylindrical cylinder, a push rod securely fixed at an upper end thereof to the underside of the pressure plate and protrudingly extending at a lower end thereof through a lower end of the cylindrical cylinder, a spring fit around the push rod in such a fashion as to be disposed between the underside of the pressure plate and the bottom surface of the cylindrical cylinder, and an acupressure probe forcibly fit around the lower end of the push rod.

Also, in the pneumatic scalp acupressure apparatus according to the present invention, preferably, the inner shell of the helmet may further comprise far infrared LEDs mounted to an inner surface thereof to emit a far infrared ray.

### BRIEF DESCRIPTION OF THE DRAWINGS

FIG. 1 is a perspective view illustrating a pneumatic scalp acupressure apparatus according to the present invention;

FIG. 2 is a cross-sectional view illustrating a pneumatic scalp acupressure apparatus according to the present invention; and

FIG. 3 is a cross-sectional view illustrating a pneumatic cylinder unit 20 of the pneumatic scalp acupressure apparatus according to the present invention;

FIG. 4 is a cross-sectional view illustrating exemplary shapes of an acupressure probe 26 of the pneumatic scalp acupressure apparatus according to alternative embodiments of the present invention; and

FIG. 5 is a schematic view illustrating a state in which acupressure probes 26 and far infrared LEDs are mounted on the inner surface of the inner shell 12 of a helmet of the pneumatic scalp acupressure apparatus according to an embodiment of the present invention.

### BEST MODE FOR CARRYING OUT THE INVENTION

Reference will now be made in detail to the preferred embodiment of the present invention with reference to the attached drawings.

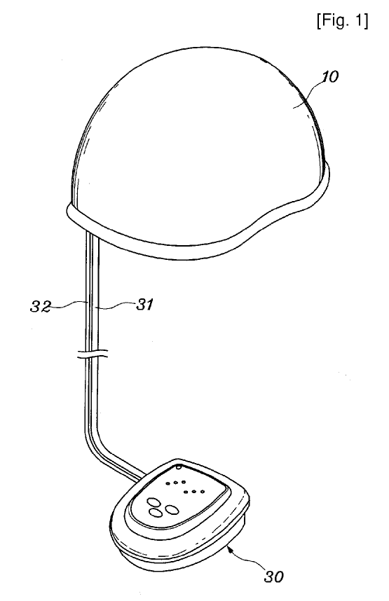

As shown in FIG. 1, a pneumatic scalp acupressure apparatus according to the present invention comprises a helmet 10, a plurality of pneumatic cylinder units 20 (not shown in FIG. 1) mounted radially inside the helmet 10, and a pneumatic pressure generator 30 interconnected to the plurality of pneumatic cylinder units 20 through a pneumatic tube 31 so as to generate air pressure to supply the generated air pressure to the inside of the cylindrical cylinder units. In FIG. 1, reference numeral 32 not illustrated denotes an electric wire.

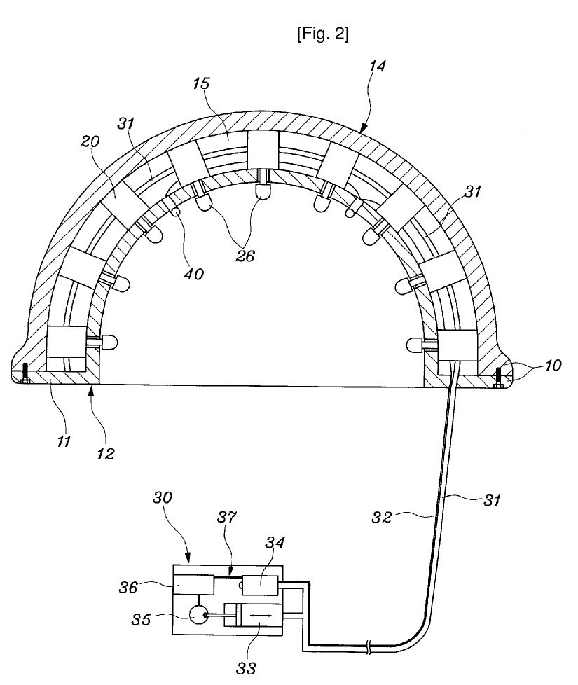

First, as shown in FIG. 2, the helmet 10 is constructed of a double structure having an inner shell 12 and an outer shell 14. The inner shell 12 is formed in a hemispherical shape and has an outwardly extending flange 11 formed at a lower end thereof in such a fashion as to extend outwardly from a peripheral edge of the lower end thereof. The inner shell 12 also has a plurality of holes formed thereon so as to allow the plurality of pneumatic cylinder units 20 to be mounted thereto. The outer shell 14 is also formed in a hemispherical shape and is engaged at a peripheral edge of a lower end thereof with the top surface of the outwardly extending flange 11 of the inner shell 2. The engagement portion between the inner shell 12 and the outer shell 14 may be adhered into one piece by means of an adhesive, and may be coupled by means of a fastening screw to enable the assembly and disassembly thereof. A space portion 15 is equidistantly defined between the inner shell 12 and the outer shell 14.

In the present invention, the helmet 10 is formed an extruded foam synthetic resin which is lightweight and rigid, preferably, an extruded polystyrene foam (so called “extruded Styrofoam”. The outer surface of the outer shell 14 is coated with various colored paints depending on a preference of a user. A chin strap (not shown) may be mounted at the lower end of the helmet 10 for the sake of convenience of the user.

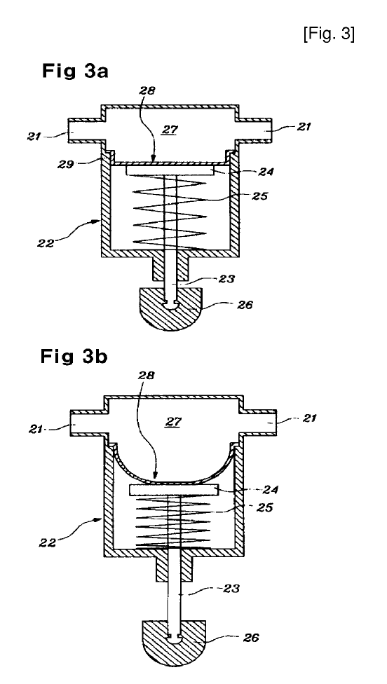

Next, as shown in FIG. 3, the plurality of pneumatic cylinder units 20 are mounted radially in the space portion 15 of the helmet 10, and each pneumatic cylinder unit includes a cylindrical cylinder 22, a push rod 23 inserted at an upper end thereof into the cylindrical cylinder 22 and protrudingly extending at a lower end thereof to be exposed to the inside of the inner shell 12 through a lower end of the cylindrical cylinder 22, a pressure plate 24 mounted on the top end surface of the push rod 23, a spring 25 fit around the push rod 23 in such a fashion as to be disposed between the underside of the pressure plate 24 and the bottom surface of the cylindrical cylinder 22, and an acupressure probe 26 forcibly fit around the lower end of the push rod 23. The lower end of the push rod 23 passes through the inner shell 12 of the helmet 10 so that the acupressure probe 26 is exposed to the inside of the inner shell 12 of the helmet 10.

The cylindrical cylinder 22 preferably has two ventilation tubes 21 formed at both sides of an upper portion thereof. The ventilation tubes 21 are interconnected to ventilation tubes 21 of adjacent cylindrical cylinders 22 by means of a pneumatic tube 31 and are finally connected to a pneumatic pressure generator 30. Thus, a pneumatic chamber 27 is formed between a ceiling of the cylindrical cylinder 22 and the top surface of the pressure plate 24 so as to allow pneumatic pressure to be supplied to the pneumatic chamber 27 through the pneumatic tube 31 to effect pneumatic pressure. An elastic rebounding force of the spring 25 is effected between the underside of the pressure plate 24 and the bottom surface of the cylindrical cylinder 22. The pneumatic chambers 27 of all the cylindrical cylinders 22 fluidically communicate with one another by means of the pneumatic tube 31 so as to maintain the same pneumatic environment.

In a preferred embodiment of the present invention, as shown in FIG. 3, a hermetically sealed plate 28 is mounted on the top surface of the pressure plate 24 made of a silicon or rubber material. The hermetically sealed flexible plate 28 is formed in a circular shape and is attached at an outer peripheral edge thereof on a stepped portion formed along an inner circumferential wall of the cylindrical cylinder 22 so as to maintain a tightly sealed state at the inside of the pneumatic chamber 27. The hermetically sealed plate 28 is made of a flexible material so as to be easily stretched as the pneumatic chamber 27 is expanded. An annular bent portion is preferably formed along the outer peripheral edge of the hermetically sealed plate 28. When the pneumatic chamber 27 is expanded, as shown in FIG. 3, the hermetically sealed plate 28 forcibly pushes the pressure plate 24 downwardly while being stretched downwardly.

In the present invention, the acupressure probe 26 is forcibly fit around the lower end of the push rod 23 in such a fashion as to be removably from the push rod 23. The acupressure probe 26 is formed of a polyurethane or silicon material having a suitable strength so as to apply a physical acupressure to a user's scalp without applying an excessive impact to the scalp. The material of acupressure probe 26 may include an anion emitting material or antibacterial material such as charcoal, tourmaline, bio stone, nano silver, etc., if necessary.

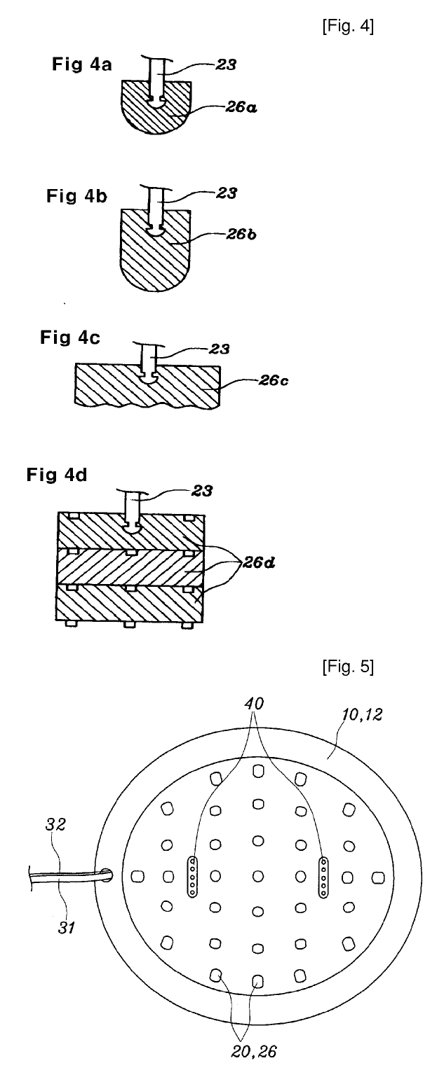

In the present invention, the acupressure probe 26 can be manufactured in various shapes and heights so as to be selectively used depending on the demand of the user. That is, an acupressure probe 26b shown in FIG. 4b is higher than that shown in FIG. 4a and an acupressure probe 26c shown in FIG. 4c is larger in surface area than that shown in FIG. 4a. And, an acupressure probe 26d shown in FIG. 4d has a plurality of grooves formed on the top surface thereof and a plurality of protrusions formed on the bottom surface thereof so that the grooves and the protrusions are correspondingly engaged with one another so as to adjust the height of the acupressure probe 26d. The protrusions formed on the underside of the acupressure probe 26d functions to increase an acupressure massage effect.

In the present invention, for example, the control unit 36 can be set to allow the air pump 33 to be operated for three seconds and the air valve 34 to be opened for one second. The control unit 36 may also be set allow the air pump 33 to be operated for six to nine seconds and the air valve 34 to be opened for two to three seconds.

Meanwhile, in another embodiment of the present invention, as shown in FIG. 5, the inner shell 12 of the helmet 10 may additionally comprise far infrared LEDs 40 mounted to an inner surface thereof to emit a far infrared ray. The far infrared LEDs 40 are mounted at two or three locations between the acupressure probes 26, and are interconnected to the control unit 36 and a power supply via the electric wire 32. The far infrared rays emitted from the far infrared LEDs 40 are known as stimulating hair-follicle cells of the user's scalp and promoting blood circulation of the peripheral capillary distributed around the hair-follicle cells to thereby prevent hair loss and promote hair growth.

### INDUSTRIAL APPLICABILITY

As described above, according to a pneumatic scalp acupressure apparatus of the present invention, a plurality of pneumatic cylinders each having an acupressure probe is radially mounted in a predetermined space portion defined between an inner shell and an outer shell made of an extruded foam synthetic resin material, and an pneumatic pressure generator serving to actuate the pneumatic cylinders is mounted separately from the helmet, so that its whole weight is light, no noise or vibration occurs, and it is very simple to use and carry.

Accordingly, it is expected to mass-produce the inventive pneumatic scalp acupressure apparatus and supply it to user at a relatively low cost, so that more patients suffering from alopecia or chronic headache can prepare it for home or personal use and utilize it conveniently whenever a scalp acupressure massage is required

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A pneumatic scalp acupressure apparatus comprising:
a helmet 10 including an inner shell 12 and an outer shell 14 which are formed in a hemispherical shape and made of an extruded foam synthetic resin material, and a space portion 15 defined between the inner shell 12 and the outer shell 14;
a plurality of pneumatic cylinder units 20 mounted radially in the space portion 15 of the helmet 10, each pneumatic cylinder unit including a cylindrical cylinder 22 having a ventilation tube 21 formed at an upper portion thereof, a pressure plate 24 mounted inside the cylindrical cylinder 22, a push rod 23 securely fixed at an upper end thereof to the underside of the pressure plate 24 and protrudingly extending at a lower end thereof through a lower end of the cylindrical cylinder 22, a spring 25 fit around the push rod 23 in such a fashion as to be disposed between the underside of the pressure plate 24 and the bottom surface of the cylindrical cylinder 22, and an acupressure probe 26 forcibly fit around the lower end of the push rod 23,
wherein the lower end of the push rod 23 passes through the inner shell 12 of the helmet 10 so that the acupressure probe 26 is exposed to the inside of the inner shell 12 of the helmet 10; and
a pneumatic pressure generator 30 for generating air pressure to supply the generated air pressure to the inside of the cylindrical cylinder, the pneumatic pressure generator including an air pump 33 and an air valve 34 interconnected to the plurality of pneumatic cylinder units 20 through a pneumatic tube 31, and a control unit 36 for controlling the operation of the air pump 33 and the air valve 34.

2. The pneumatic scalp acupressure apparatus according to claim 1, wherein the inner shell 12 of the helmet 10 further comprises far infrared LEDs mounted to an inner surface thereof to emit a far infrared ray.

3. The pneumatic scalp acupressure apparatus according to claim 1, wherein the cylindrical cylinder 22 of each pneumatic cylinder unit 20 includes a stepped portion formed along an inner circumferential wall thereof for allowing a, hermetically sealed flexible plate 28 to be attached thereon, and the pressure plate 24 is mounted to the underside of the hermetically sealed flexible plate 28.

4. The pneumatic scalp acupressure apparatus according to claim 1, wherein the acupressure probe 26 is removable from the push rod 23 and adjustable in its height.

5. The pneumatic scalp acupressure apparatus according to claim 2, wherein the cylindrical cylinder 22 of each pneumatic cylinder unit 20 includes a stepped portion formed along an inner circumferential wall thereof for allowing a hermetically sealed flexible plate 28 to be attached thereon, and the pressure plate 24 is mounted to the underside of the hermetically sealed flexible plate 28.

6. The pneumatic scalp acupressure apparatus according to claim 2, wherein the acupressure probe 26 is removable from the push rod 23 and adjustable in its height.
